(19) United States
(12) Patent Application Publication
(10) Pub. No.: US 2023/0392754 A1
(43) Pub. Date: Dec. 7, 2023

(54) MOUNTING STRUCTURE OF TANK

(71) Applicant: TOYOTA JIDOSHA KABUSHIKI KAISHA, Toyota-shi (JP)

(72) Inventors: Akihiko OHBA, Toyota-shi (JP); Shinnosuke SAKO, Toyota-shi (JP); Shusuke INAGI, Toyota-shi (JP)

(73) Assignee: TOYOTA JIDOSHA KABUSHIKI KAISHA, Toyota-shi (JP)

(21) Appl. No.: 18/296,561

(22) Filed: Apr. 6, 2023

(30) Foreign Application Priority Data
Jun. 1, 2022 (JP) 2022-089356

(51) Int. Cl. F17C 13/08

(52) U.S. Cl. CPC F17C 13/084; F17C 2201/0109; F17C 2205/0107; F17C 2205/013

(57) ABSTRACT

A tank mounting structure for holding a tank includes two first frames that hold both ends of the tank and surround the tank, and a second frame disposed between the two first frames.

### CROSS-REFERENCE TO RELATED APPLICATION

This application claims priority to Japanese Patent Application No. 2022-089356 filed on Jun. 1, 2022, incorporated herein by reference in its entirety.

### BACKGROUND

### 1. Technical Field

The present disclosure relates to a mounting structure of a tank.

### 2. Description of Related Art

Japanese Unexamined Patent Application Publication No. 2003-211982 (JP 2003-211982 A) discloses a structure in which a tank is mounted in a space adjacent to a luggage compartment (FIG. 1 and paragraph 0032).

Japanese Unexamined Patent Application Publication No. 2022-049006 (JP 2022-049006 A) discloses a pressure vessel with frames on both sides of a tank (FIG. 1).

Japanese Unexamined Patent Application Publication No. 2009-012741 (JP 2009-012741 A) discloses a mount structure of a tank, the mounting structure including a frame surrounding both ends of the tank (FIG. 3).

### SUMMARY

In a conventional tank mounting structure, when a tank is mounted in a luggage compartment of a vehicle, there is a possibility that luggage slip due to a sudden brake and the like and collide with the tank.

The present disclosure has been made in view of these circumstances, and an object of the present disclosure is to provide a tank mounting structure capable of suppressing luggage and the like from colliding with a tank.

The present application discloses a mounting structure of a tank in which the mounting structure holds the tank, the mounting structure including:
two first frames that hold both ends of the tank and that surround the tank; and
a second frame that is disposed between two first frames.

The second frame may have a shape that surrounds the tank.

According to the present disclosure, it is possible to suppress luggage from colliding with a tank.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view schematically showing the appearance of a high-pressure tank 10;

FIG. 2 is a view schematically showing a cross section of the high-pressure tank 10;

FIG. 3 is a perspective view of the mounting structure 20 of the tank;

FIG. 4 is a plan view of the mounting structure 20 of the tank;

FIG. 5 is a front view of the mounting structure 20 of the tank;

FIG. 6 is a side view of the mounting structure 20 of the tank;

FIG. 7 is a perspective view of a tank mounting structure 20 on which a tank 10 is mounted;

FIG. 8 is a plan view of a mounting structure 20 of a tank equipped with a tank 10; and

FIG. 9 is a perspective view of the mounting structure 20′ of the tank.

### DETAILED DESCRIPTION OF EMBODIMENTS

1. Structure of the High-Pressure Tank

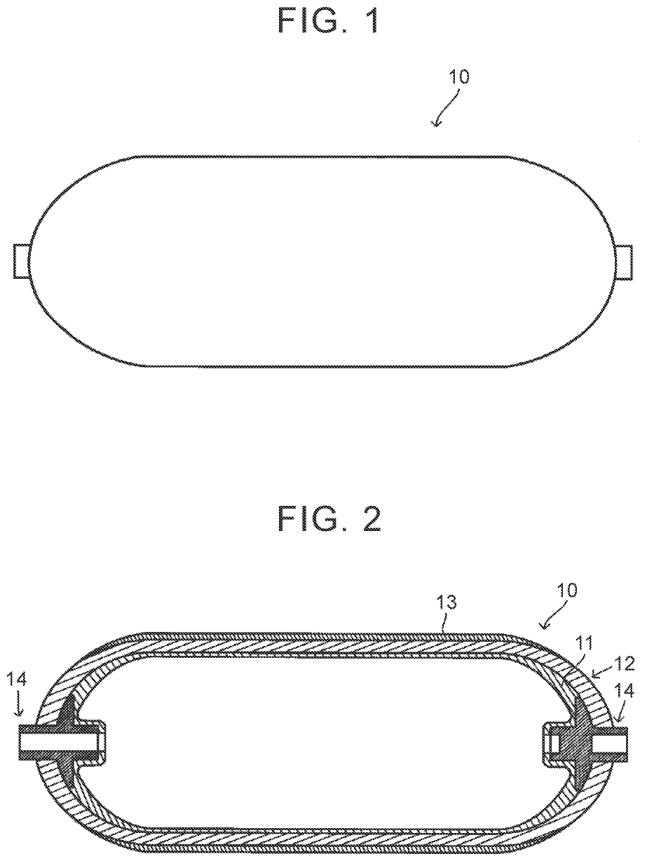

FIG. 1 schematically shows the appearance of a high-pressure tank 10 according to one embodiment, and FIG. 2 schematically shows a cross section along the axis of the high-pressure tank 10. As can be seen from these figures, in the present embodiment, the high-pressure tank 10 includes a liner 11, a reinforcing layer 12, a protective layer 13, and a base 14. Each configuration will be described below.

1.1. Liner

The liner 11 is a hollow member that partitions the internal space of the high-pressure tank 10. The liner 11 may be made of a material capable of holding the material contained in the internal space (e.g., hydrogen) without leaking. The liner 11 may be made of a known material, for example, a nylon resin, a polyethylene-based synthetic resin, or a metal such as stainless steel or aluminum.

The thickness of the liner 11 is not particularly limited, but is preferably 0.5 mm to 1.0 mm.

1.2. Reinforcing Layer

The reinforcing layer 12 includes a resin in which fibers are laminated over a plurality of layers and the fibers are impregnated and cured. The fiber-based layer is formed by winding a fiber bundle over a number of layers up to a predetermined thickness on the outer surface of the liner 11.

The thickness of the reinforcing layer 12 is determined by the necessary strength, and is not particularly limited. The thickness of the reinforcing layers 12 is of the order of 10 mm to 30 mm.

Carbon fibers are used for the fiber bundle of the reinforcing layer 12. The fiber bundle has a band shape having a predetermined cross-sectional shape (for example, a rectangular cross-section) as a bundle of carbon fibers. Although not particularly limited, the cross-sectional shapes include a rectangular shape having a width 6 mm to 10 mm and a thickness of about 0.1 mm to 0.15 mm. The amount of the carbon fiber contained in the fiber bundle is not particularly limited, but may be, for example, about 36000 carbon fibers.

The resin impregnated in the fiber and cured in the reinforcing layer 12 is not particularly limited as long as it can increase the strength of the fiber. Examples thereof include thermosetting resins, which are cured by heat, and examples thereof include an amine-based or anhydride-based curing accelerator, an epoxy resin containing a rubber-based reinforcing agent, and an unsaturated polyester resin. In addition, a resin composition containing an epoxy resin as a main agent and cured by mixing a curing agent therewith can also be mentioned. According to this configuration, the resin composition, which is a mixture of the main agent and the curing agent, reaches and penetrates the fiber layer during the period from the mixing to the curing, and thereby the resin composition is automatically cured.

1.3. Protective Layer

The protective layer 13 is a layer disposed on the outer periphery of the reinforcing layer 12 as necessary. When the protective layer 13 is provided, for example, glass fibers are wound and impregnated with a resin. The impregnated resin can be considered similar to the reinforcing layer 12. Thus, impact resistance can be imparted to the high-pressure tank 10.

The thickness of the protective layers 13 is not particularly limited, but may be about 1.0 mm to 2.0 mm.

1.4. Base

The base 14 is a member attached to each of the two open ends of the liner 11, and one of them functions as an opening for communicating the inside and outside of the high-pressure tank 10, and also functions as an attachment portion for attaching a pipe or a valve to the high-pressure tank 10.

2. Tank Mounting Structure

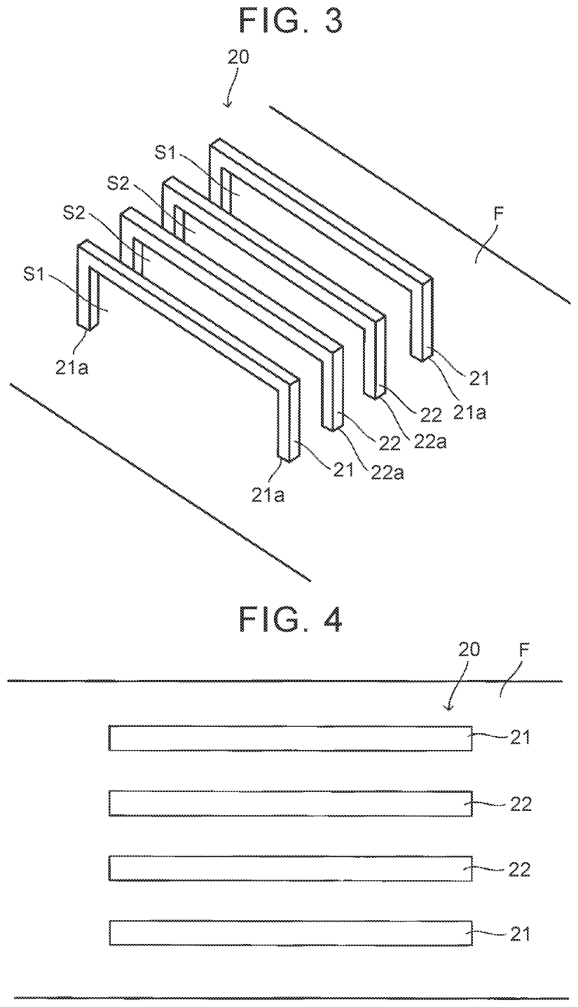

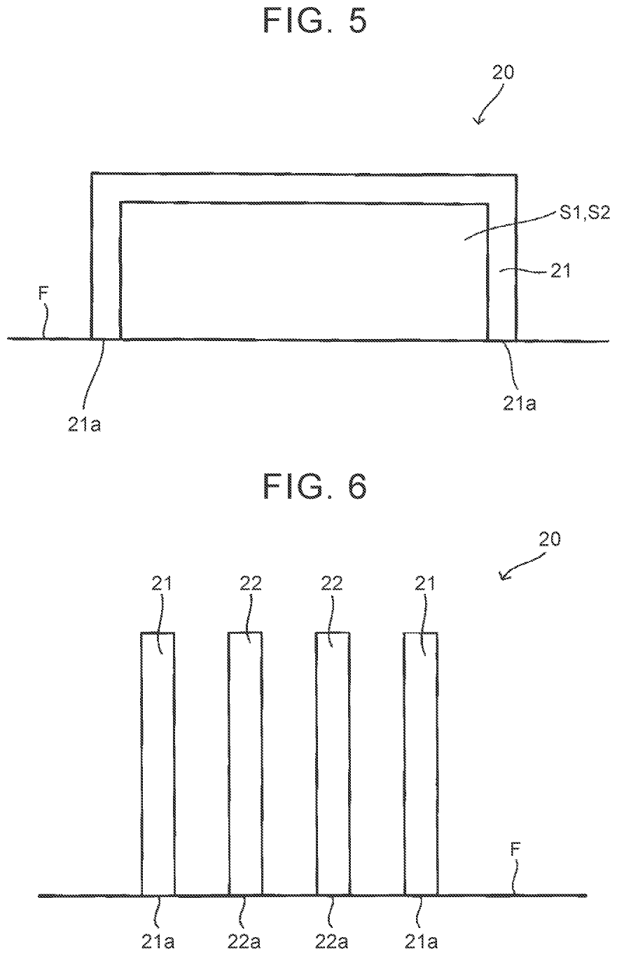

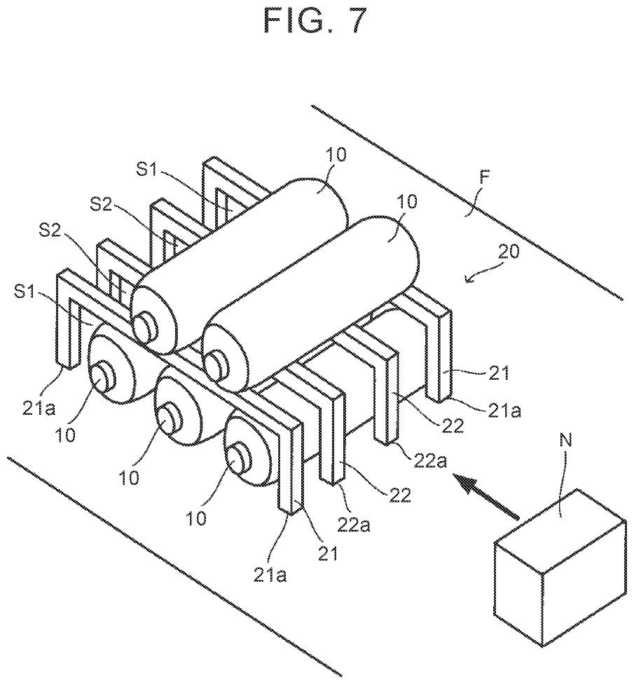

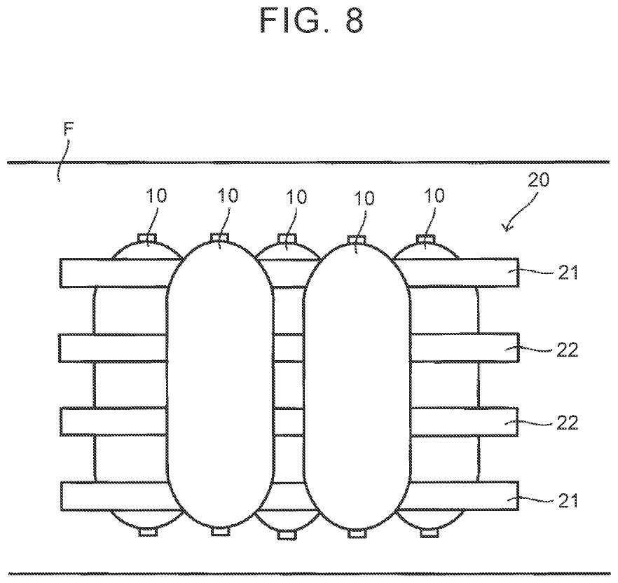

A tank mounting structure 20 according to one example will be described with reference to the drawings. FIG. 3 is a perspective view of the tank mounting structure 20. FIG. 4 is a plan view of the tank mounting structure 20. FIG. 5 is a front view of the tank mounting structure 20. FIG. 6 is a side view of the tank mounting structure 20. FIG. 7 is a perspective view of the tank mounting structure 20 in a scene in which the high-pressure tank 10 is mounted. FIG. 8 is a plan view of the tank mounting structure 20 in a scene in which the high-pressure tank 10 is mounted.

As can be seen from these figures, the tank mounting structure 20 includes a first frame 21 and a second frame 22.

2.1. First Frame

The first frame 21 is a frame-shaped member with a part thereof missing, and two end portions 21a of the missing portions are fixed to the floor surface F. Therefore, a space S1 surrounded by the first frame 21 and the floor surface F is formed. In the present embodiment, the first frame has a rectangular frame shape and has a shape without one side (a missing portion). Here, the floor surface F is, for example, a loading platform of a vehicle, and the tank mounting structure 20 is provided in the vehicle.

In the tank mounting structure 20, two first frames 21 are provided at intervals. As can be seen from FIGS. 7 and 8, an end portion of the high-pressure tank 10 (a portion close to the base 14) is disposed in the space S1 of the first frame 21, and both ends of the high-pressure tank 10 are held so as to be surrounded by two first frames 21.

The material forming the first frame 21 is not particularly limited, but is preferably metal from the viewpoint of securing strength. The shape of the frame member of the first frame 21 having a frame shape is not particularly limited, and examples thereof include a quadrangular cross section and a circular cross section. The thickness is not particularly limited as long as the strength can be secured.

2.2. Second Frame

Like the first frame 21, the second frame 22 of the present embodiment is a frame-shaped member that is partially omitted. Two end 22a of the missing part are fixed to the floor surface F. Therefore, a space S2 surrounded by the second frame 22 and the floor surface F is formed. In the present embodiment, the second frame 22 has a rectangular frame shape. The second frame 22 has a shape without one side (missing portion).

In the tank mounting structure 20, two second frames 22 are provided between the first frames 21. As can be seen from FIG. 7 and FIG. 8, a body portion of the high-pressure tank 10 (a portion closer to the center in the longitudinal direction than the base 14) is disposed in the space S2 of the second frame 22, and the body portion of the high-pressure tank 10 is held so as to be surrounded by the second frame 22.

The material forming the second frame 22 is not particularly limited, but is preferably metal from the viewpoint of securing strength. Further, the shape of the frame member of the second frame 22 having a frame shape is not particularly limited. Examples of the shape of the frame member of the second frame 22 having a frame shape include a quadrangular cross section and a circular cross section. The thickness is not particularly limited as long as the strength can be secured.

Although an example in which two second frames 22 are provided has been described in the present embodiment, the number of second frames is not necessarily two, and may be one or three or more.

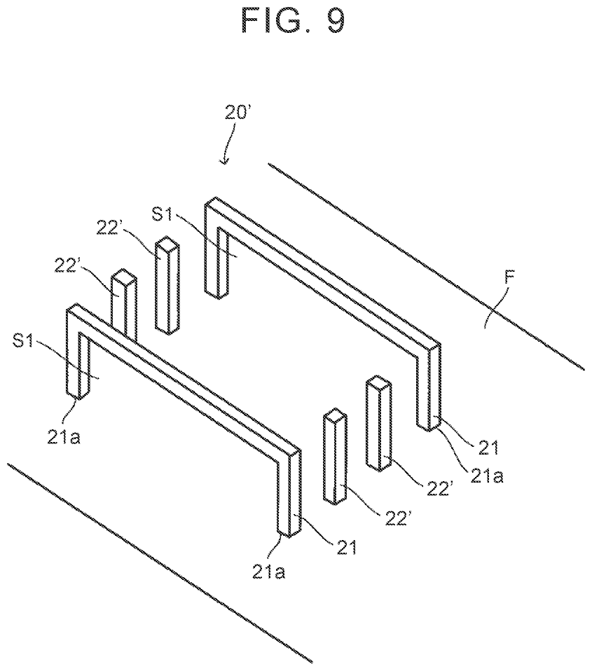

Further, as shown in the tank mounting structure 20′ of the modified example in FIG. 9, the second frame 22′ does not necessarily have to surround the high-pressure tank 10, and may be a columnar member provided so as to stand between the first frames 21. At this time, the second frame 22′ is disposed between the frame members having the end 21a of the two first frames 21. As a result, it is possible to operate as described later.

3. Effects

According to the tank mounting structure of the present disclosure, the second frame 22 is disposed between the first frames 21. Therefore, even when the load N placed on the floor surface F moves toward the high-pressure tank 10 for some reason as shown in FIG. 7, it is possible to prevent the load from colliding with the high-pressure tank 10 by the second frame 22.

For example, in a case where the tank mounting structure is disposed in a fuel cell electric vehicle and the high-pressure tank is a tank in which hydrogen, which is fuel, is stored, the tank mounting structure of the present disclosure is particularly useful because it is important to avoid a collision of a load due to its nature. In this case, the tank is fixed so as not to be movable with respect to the floor by a tank fixing means (band or the like) (not shown). Further, in a case where the second frame 22 is shaped to surround the high-pressure tank 10 as in the example of FIG. 3 and FIG. 7 (the tank mounting structure 20), the strength of the tank mounting structure can be increased.

What is claimed is:

1. A mounting structure of a tank, the mounting structure holding the tank, the mounting structure comprising:
two first frames that hold both ends of the tank and that surround the tank; and
a second frame that is disposed between the two first frames.

2. The mounting structure according to claim 1, wherein the second frame has a shape that surrounds the tank.
